(19) United States
(12) Patent Application Publication
(10) Pub. No.: US 2026/0320169 A1
(43) Pub. Date: Oct. 15, 2026

(54) Augmented Reality Display for Security Information

(71) Applicant: Siemens Aktiengesellschaft, München (DE)

(72) Inventor: Rainer Falk, Erding (DE)

(73) Assignee: Siemens Aktiengesellschaft, München (DE)

(21) Appl. No.: 19/119,050

(22) PCT Filed: Sep. 29, 2023
(86) PCT No.: PCT/EP2023/077035

§ 371 Date: Apr. 7, 2025

(30) Foreign Application Priority Data
Oct. 5, 2022 (EP) 22199765.3

(51) Int. Cl. G06F 21/36; G02B 27/01; G06F 9/451; G06F 11/34; H04W 12/33

(52) U.S. Cl. CPC G06F 21/36; G02B 27/017; G06F 9/453; G06F 11/3438; H04W 12/33; G02B 2027/0138; G02B 2027/0178

(57) ABSTRACT

Various embodiments of the teachings herein include a method for displaying security information designed to release a lock protecting access to a device. An example includes: capturing a visual identification of the device and generating device identification information; transmitting the device identification information; receiving security information associated with the device identification information; displaying a visual output comprising at least one extract of an image of the device and the security information; and displaying a visual aid for using the security information to release the lock.

### CROSS-REFERENCE TO RELATED APPLICATIONS

This application is a U.S. National Stage Application of International Application No. PCT/EP2023/077035 filed Sep. 29, 2023, which designates the United States of America, and claims priority to EP Application No. 22199765.3 filed Oct. 5, 2022, the contents of which are hereby incorporated by reference in their entirety.

### TECHNICAL FIELD

The present disclosure relates to display of security information. Various embodiments of the teachings herein include augmented reality devices and/or methods for transmitting security information using an associated AR background system.

### BACKGROUND

Control units are used in industrial automation systems, in particular in production environments. Although remote access via a data communication link is possible in many cases, direct local access to the local user interface is also important. To enable access to critical functions, a device code, in particular a PIN or password, must be entered. This is carried out according to the respective protection level and/or to enable the configuration functions.

Password stores are known, in particular for PCs or mobile devices. These allow a user to access the stored passwords after entering a master password. In particular, the user can type in a password or copy it to an input field via “Copy&Paste”. It is also known that web browsers store passwords in a similar way to a password store and use them to automatically populate the fields in a web interface.

When accessing a device remotely, it is known for the accessing device or the accessing user to be authenticated cryptographically or by means of a password. In addition, the use of augmented reality (AR) in production is well known. This allows service technicians to view manuals, in particular. AR-based solutions for industry are also known, in which objects that the AR user, e.g. a service technician, is currently seeing are automatically recognized or that additional information is inserted into the field of view for the local AR user via the AR glasses.

### SUMMARY

The teachings of the present disclosure provide improved solutions for local access to a device protected by a code. For example, some embodiments of the teachings herein include a method for outputting a display of security information (211), wherein the security information (211) is designed to release a lock which is designed to protect access to a device (1) to be protected, the method including: visually capturing (S1) a device identification (12) of the device (1) to be protected, whereby device identification information is generated, transmitting (S2) the device identification information, receiving (S3) the security information (211), said security information (211) being assigned to the device identification information (12), outputting (S4) a visual display (21), said visual display (21) comprising at least one extract of an image (212) of the device (1) to be protected and the display of the security information (211), and additionally outputting (S5) a visual aid (213) for using the security information (211) in order to release the lock.

In some embodiments, the security information (211) is implemented as: a device code and/or a PIN code and/or a release code and/or a password and/or a numerical code and/or an alphanumeric code.

In some embodiments, the visual display (21) is designed as an augmented reality display.

In some embodiments, the visual aid (213) is implemented as: an augmentation of an area of a control panel (13) for entering the security information (211) and/or an augmentation of a key of a number pad for entering the security information (211) and/or a warning indication indicating an incorrect entry of the security information (211).

In some embodiments, the method further comprises capturing (S6) a user action arranged on or relative to the device (1) to be protected.

In some embodiments, the visual aid (213) is output in response to an evaluation of the user action.

In some embodiments, the method further includes transmitting validation information (211) before receiving the security information (S3).

In some embodiments, the validation information is implemented as: device authentication information and/or position information and/or user authentication information and/or application information of a user device.

As another example, some embodiments include an augmented reality device (2) designed to carry out one or more of the methods described herein.

In some embodiments, the augmented reality device (2) comprises: AR glasses and/or a portable mobile device, in particular a smartphone, smartwatch or tablet.

As another example, some embodiments include a method for transmitting security information (211), wherein the security information (211) is designed to release a lock which is designed to protect access to a device (1) to be protected, having the steps of: receiving device identification information, wherein the device identification information is formed as a visual recording of a device identification (12) of the device (1) to be protected, checking the device identification information, transmitting the security information (211) depending on a result of checking the device identification information, the security information (211) being assigned to the device identification information, and transmitting a further data record comprising an additional visual aid (213) for using the security information (211) for access to the device (1) to be protected, wherein the visual aid (213) is designed to be output in addition to the security information (211).

In some embodiments, the method further comprises: transmitting a data record comprising a visual display (21), said visual display (21) comprising at least one extract of an image (212) of the device (1) to be protected and the display of the security information (211) and/or evaluating a user action arranged on or relative to the device (1) to be protected and/or receiving validation information before transmitting the security information (211) and/or checking the validation information, wherein the transmission of the security information (211) also takes place depending on a result of the validation information checking.

As another example, some embodiments include an AR background system designed to carry out one or more of the methods described herein.

### BRIEF DESCRIPTION OF THE DRAWINGS

The special features and advantages of the teachings herein are apparent from the following explanations of multiple exemplary embodiments using the schematic drawings. In the drawings:

FIG. 1 shows a flow diagram of an example method incorporating teachings of the present disclosure; and

FIG. 2 shows a schematic drawing of an example device to be protected and an augmented reality device incorporating teachings of the present disclosure.

### DETAILED DESCRIPTION

The teachings of the present disclosure include methods for outputting a display of security information. In an example, the security information is designed to release a lock which is designed to protect access to a device to be protected, and the method includes:
visually capturing a device identification of the device to be protected, whereby device identification information is generated,
transmitting the device identification information,
receiving the security information, said security information being assigned to the device identification information, and
outputting a visual display, said visual display comprising at least one extract of an image of the device to be protected and the display of the security information, and
outputting a visual aid for using the security information to access the device.

The device to be protected may be a device of an industrial automation system in a production environment, e.g. a control unit.

In some embodiments, the lock protects access to a local device interface of the device. Releasing the lock allows access to the local device interface of the device. The local device interface is designed in particular as a local user interface and therefore does not involve remote access via a data communication link.

In some embodiments, the device is a control cabinet or an electronic lock of a door to an equipment room. In this embodiment, the access protection is entry protection.

In some embodiments, the access protection is:
an electronic lock of a control cabinet and/or
an electronic lock of a door to an equipment room in which the device is located and/or
an administrative function of the device, in particular a protection level of the device and/or a configuration menu of the device.

The security information allows access to the device. Thus, access to the device is protected, in particular blocked, by access protection, in particular entry protection. The security information enables the release of the access protection, in particular the entry protection and hence the access to the device, in particular to a local device interface of the device.

In some embodiments, the capturing of the device identification of the device is a visual recording. In some embodiments, the recording takes place via a camera. A user is in a position in which his/her camera has the device, and in particular the device identification, in its field of view. By means of the methods described herein, a recording of the device identification is made. This can be initiated by a user action or automatically as soon as a device identification is detected by the camera. In any case, the user must be near to the device. The device identification must be visible from the position of the user, so that the recording can take place.

The device identification information enables the device to be uniquely identified. In some embodiments, the device identification is a unique device image, a device label, an equipment label, an identifier or a device ID. The device identification may be a visual device identification. The device identification information is a file or contains data of the form in which the device identification has been captured. The device identification information may be a photograph or information obtained by image processing from a photograph of the device identification. In some embodiments, the device identification is captured via a camera.

In some embodiments, the security information is received by a receiving unit and is transmitted by a password store, also known as a password storage unit or security code database. The security information is thus retrieved from the password store. In some embodiments, the security codes stored in the security code database are stored in encrypted form.

In some embodiments, the pure security information is received and the AR device (an AR-capable device) generates the display of the security information from said information. In some embodiments, the display of the security information has already been received and the security information is thus received from this already in processed form.

A visual display is generated which comprises at least one extract of an image of the device to be protected and a display of the security information. In some embodiments, the image of the device comprises a live video reproduction of a view of the device. The security information is generated in addition to the extract of the image of the device or an image of the device as a whole together with the visual display. The security information is thus arranged relative to the image of the device and displayed near to the device and superimposed on the device, in the field of view of the user.

The methods described may offer the advantage that a user, in particular a service technician and/or an augmented reality (AR) user who has not memorized the corresponding security information does not have to bring along the corresponding security information, in particular security codes, manually on a slip of paper or need to ask other service technicians, for example, by telephone, for the corresponding security information. This not only improves the level of security, but also reduces the time required to release the necessary lock and the access protection. In addition, accesses performed can be logged and thus traced.

The devices described herein include means, especially those resulting from an industrial 5G augmented reality system in a production environment, in order to simplify the input of conventional security information, in particular device codes and/or PINs.

In some embodiments, the visual aid is provided in addition to the security information. Thus, the visual aid differs from the security information itself. The fact that the visual aid is suitable “for using the security information” also includes the fact that the visual aid makes it easier for the AR user to use the security information to release the lock, that is, assists the AR user in this process. Thus, the visual aid for using the security information is additionally transmitted for releasing the lock. The visual aid is thus output in addition to the visual display, which comprises the extract of the image of the device to be protected and the display of the security information.

The visual aid helps a user to enter the security information correctly. The visual aid thus assists a user when releasing the lock by correctly using the security information. In some embodiments, the visual aid is an augmented reality output and is output via an AR-capable device.

In some embodiments, the security information is:
a device code and/or
a PIN code and/or
a release code and/or
a password and/or
a numerical code and/or
an alphanumeric code.

The security information enables access to the device by releasing the access protection, as described above. The security information may include a series of characters, which is requested from a user.

In some embodiments, the visual display is designed as an augmented reality display. In some embodiments, the visual display comprises at least one extract of an image of the device to be protected and the display of the security information. The image of the device comprises, as described above, a live video reproduction of a visual field of the device. The security information is transmitted in addition to the extract of the image of the device or an image of the device as a whole together with the visual display. The security information is thus arranged relative to the image of the device, e.g. displayed near to the device and superimposed on the device, in the visual field of the user.

For the technical implementation of the output of the visual display, in particular well-known augmented reality methods are used. The AR system displays the security information, in particular the corresponding code, in the AR user's visual field.

In some embodiments, the visual aid is:
an augmentation of an area of a control panel for entering the security information and/or
an augmentation of a key of a number pad for entering the security information and/or
a warning indication.

In some embodiments, an augmentation can also be referred to as a visual highlighting, in particular using augmented reality technology. The corresponding control panel is also highlighted, in particular after it has been detected by the AR system, in particular the corresponding keys of a keypad being highlighted.

In some embodiments, the method comprises capturing a user action arranged on or relative to the device. Thus, it is possible to detect a user action taken by a user, in particular an input of the security information, in particular by detecting the key press using image evaluation. It is also possible to monitor whether the AR user has actually made the correct input on the control panel.

In some embodiments, the visual aid is output in response to an evaluation of the user action. A character is output as a visual aid in response to the evaluation of a previously performed user input. The output is made in particular via a display and/or an AR system, via which the visual display according to the invention is also output. The character is formed in particular as an asterisk ‘*’ representing the previously made user input.

The visual aid can also be used to highlight the next character or number to be entered in the form of a visually displayed character string or sequence of digits, or else only the next character or digit to be entered can be displayed.

Furthermore, if monitoring is used to determine whether the AR user has actually made the correct input on the control panel, the user can be informed by the visual aid that an incorrect input has been made. This is carried out in particular by means of a warning indication, in which the incorrect entry in particular is highlighted in red.

In some embodiments, the method comprises transmitting validation information before receiving the security information. The validation information is transmitted in particular after the device identification information has been visually captured. The validation information confirms that the sender of the device identification information is authorized to receive the security information. The validation information is checked by the sender of the security information before the information is sent.

In some embodiments, the validation information is:
device authentication information and/or
position information and/or
user authentication information and/or
application information of a user device.

By means of the device authentication information, the device from which the device identification originates is able to be authenticated. In particular, the device authentication information is implemented as unit authentication information. In particular, the device authentication information assigned to the device or the associated input field is detected. This is carried out in particular by object recognition or by means of a barcode attached to the device, in particular a 2D barcode or a QR code. As a result, it can be checked whether the AR user is actually currently located in front of the corresponding device and whether the input field is currently usable, in particular not covered by a covering flap, or whether the input of a security code is currently actually expected by the device according to a device display.

The position information allows detection of whether the user, or the AR glasses or AR device they are using, is located in the vicinity of the device or input field. This can also be carried out by image evaluation. In addition, position information can also be captured and checked by a localization system, in particular RFID, NFC, WLAN, UWB, or 5G mobile radio.

By means of the user authentication information, the wearer of a pair of AR glasses, one embodiment of an AR device, can be identified and/or authenticated. This is carried out in particular by biometric authentication, in particular by means of a camera that recognizes the iris pattern and/or the back of the eye in the case of AR glasses, or by means of an acoustic fingerprint (ultrasound) of the wearer or their head, whereby an acoustic fingerprint of the skull bone is detected and verified.

The application information of the user device provides information about an application, in particular a correct or incorrect application of the user device. The user device is in particular a mobile device, in particular a smart device or tablet with an AR application, or a pair of AR glasses. The application information allows a check of whether the AR glasses are properly fitted. In particular, the position of the AR glasses can be detected by position sensors or touch sensors, in particular on the nose bridge and/or legs of the AR glasses. It can also be verified that the eye is actually located at the expected distance or position with respect to the AR glasses.

In some embodiments, the security information stored in the security code database is stored in encrypted form. In some embodiments, the cryptographic key for decrypting the encrypted security information can only be released if the validation information has been checked and, in particular, the use of the security information by an AR user is currently permitted.

Some embodiments include an augmented reality device designed to carry out one or more of the methods described herein. The device is a user device which is designed to output an augmented reality display to the user. The augmented reality display extends a display of the real situation which is in the user's field of view by an enhancement, the augmentation. The extract of the image of the device to be protected within the meaning of the invention corresponds to the reality. The display of the security information within the meaning of the invention is indicated by the augmentation.

In some embodiments, the augmented reality device is:
AR glasses and/or
a portable mobile device, in particular a smartphone, smartwatch or tablet.

The mobile device is provided with an AR app and in particular also has an authentication function of the user by way of a fingerprint recognition.

Some embodiments include a method for transmitting security information, wherein the security information is designed to release a lock which is designed to protect access to a device to be protected, the method including:
receiving device identification information, wherein the device identification information is formed as a visual recording of a device identification of the device to be protected,
checking the device identification information,
transmitting the security information depending on a result of checking the device identification information, the security information being assigned to the device identification information, and
transmitting a further data record comprising an additional visual aid for using the security information for access to the device to be protected, wherein the visual aid is designed to be output in addition to the security information.

The method for transmitting security information is written from the viewpoint of an AR background system. The method described above for outputting a display of security information describes the invention from the viewpoint of the corresponding user device.

In some embodiments, the method for sending a security information comprises at least one of:
transmitting a data record comprising a visual display, said visual display comprising at least one extract of an image of the device to be protected and the display of the security information and/or
evaluating a user action arranged on or relative to the device to be protected and/or
receiving validation information before transmitting the security information and/or
checking the validation information, wherein the transmission of the security information also takes place depending on a result of the validation information checking.

Some embodiments include an AR background system designed to carry out one or more of the methods described herein for transmitting security information. Data transmission between the AR device, in particular the AR glasses, and the AR background system takes place in particular via a 5G mobile radio system. However, in particular WLAN communication is also used. The data transmission between the AR device and the AR background system is in particular cryptographically protected, in particular encrypted, integrity protected and/or authenticated.

Some embodiments include a computer program product comprising a computer program, wherein the computer program can be loaded into a memory device of a computing unit, wherein the computer program carries out one or more of the methods described herein when the computer program is executed on the computing unit.

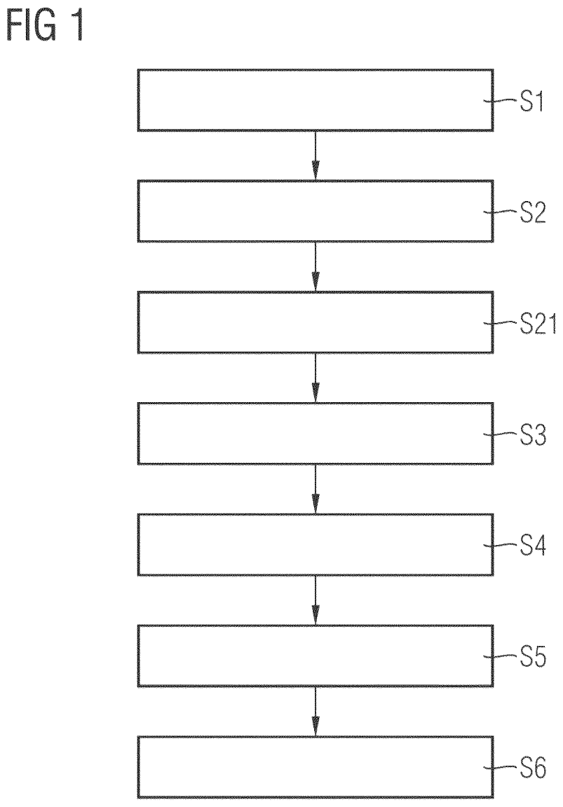

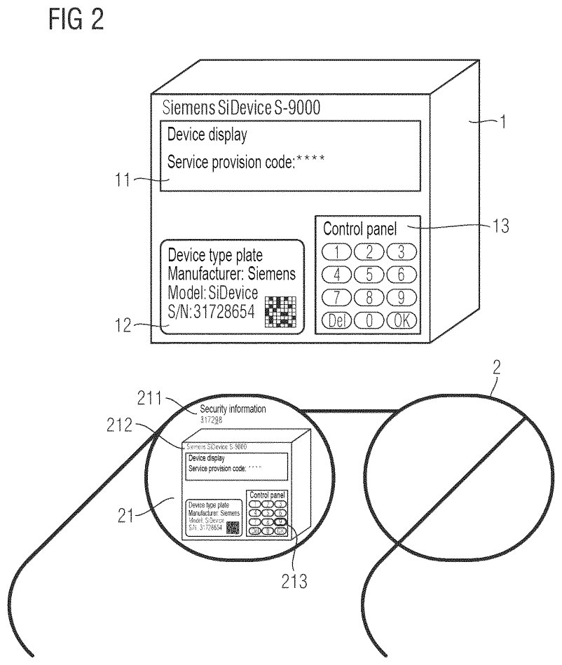

FIG. 1 shows a flowchart of an example method incorporating teachings of the present disclosure for displaying security information 211 (shown in FIG. 2), wherein the security information 211 is designed to release a lock which is designed to protect access to a device 1 to be protected (shown in FIG. 2), the method including:
Step S1: visually capturing a device identification 12 (shown in FIG. 2) of the device 1 to be protected (shown in FIG. 2), whereby device identification information is generated,
Step S2: transmitting the device identification information,
Step S21: transmitting validation information before receiving the security information S3,
Step S3: receiving the security information 211, said security information 211 being assigned to the device identification information 12,
Step S4: outputting a visual display 21 (shown in FIG. 2), said visual display 21 comprising at least one extract of an image 212 (shown in FIG. 2) of the device 1 to be protected and the display of the security information 211,
Step S5: outputting a visual aid 213 (shown in FIG. 2) for using the security information 211 for access to the device (1) to be protected, and
Step S6: capturing a user action arranged on or relative to the device 1 to be protected.

FIG. 2 illustrates the design of an example device incorporating teachings of the present disclosure. The security information 211 in FIG. 2 can be described as a device code, a PIN code, a release code and/or a numerical code.

The visual display 21 is implemented as an augmented reality display 21 of an augmented reality device 2. The visual aid (213) is implemented in FIG. 2 as:
an augmentation of an area of a control panel (13) for entering the security information (211) and
an augmentation of a key of a number pad for entering the security information (211).

The visual aid 213 is output in response to an evaluation of the user action. In the case of an industrial device 1, a code must be entered by a user on a keypad 13, in particular to enable the service functionality. For this purpose, the access code 211 (here: 317298 for the left eye) is displayed to the service technician as the AR user in their AR glasses 2.

The security information 211 in FIG. 2 can be described as a device code, a PIN code, a release code and/or a numerical code.

The visual aid 213 is implemented in FIG. 2 as:
an augmentation of an area of a control panel 13 for entering the security information 211 and
an augmentation of a key of a number pad 13 for entering the security information 211.

As the visual aid 213, here the key corresponding to the next digit to be entered is visually indicated in the AR glasses 2 (here the key “9”). For this purpose, the camera of the AR glasses 2 can detect that four digits have already been entered (in particular from the display of the four asterisks ‘***’ in the device display 11). Furthermore, the device 1 can be recognized, in particular by capturing the device appearance or the device type plate 12.

The teachings can be realized completely in the AR glasses 2 or another AR device. In some embodiments, the AR glasses 2 or the other AR device is connected to an AR background system, in particular via WLAN or a 5G mobile radio network. This enables image acquisition and image evaluation, in particular by object recognition, to take place in the background system, in particular a backend or edge computing system or in a 5G Multi Access Edge Computing infrastructure of a mobile radio system. Likewise, the additional information to be displayed by the AR glasses 2, in particular information for device maintenance, can be determined there and transmitted to the AR glasses 2, in particular by evaluating the image captured by the AR glasses 2 and by querying the code which is stored in the security code database and assigned to the device located in the field of view.

Data transmission between the AR glasses 2 and the AR background system can take place in particular via an SG-Mobile radio system. In particular, however, WLAN communication can also be used. Data transmission is in particular cryptographically protected, in particular encrypted, integrity protected and/or authenticated.

Although the teachings of the present disclosure have been illustrated and described in detail by means of the exemplary embodiments, the scope of the disclosure is not restricted by the examples, and other variations can be derived therefrom by the person skilled in the art without departing from the scope of protection thereof.

What is claimed is:

1. A method for displaying security information designed to release a lock protecting access to a device, the method comprising:
capturing a visual identification of the device and generating device identification information;
transmitting the device identification information;
receiving security information associated with the device identification information;
displaying a visual output comprising at least one extract of an image of the device and the security information; and
displaying a visual aid for using the security information to release the lock.

2. The method as claimed in claim 1, wherein the security information comprises a code selected from the group consisting of:
a device code,
a PIN code,
a release code,
a password,
a numerical code, and
an alphanumeric code.

3. The method as claimed in claim 1, wherein the visual output includes an augmented reality display.

4. The method as claimed in claim 1, wherein the visual aid includes:
an augmentation of an area of a control panel for entering the security information,
an augmentation of a key of a number pad for entering the security information, and/or
a warning indication indicating an incorrect entry of the security information.

5. The method as claimed in claim 1, further comprising
capturing a user action arranged on or relative to the device.

6. The method as claimed in claim 1, further comprising:
capturing user action arranged on or relative to the device; and
displaying the visual aid based on an evaluation of the user action.

7. The method as claimed in claim 1, further comprising
transmitting validation information before receiving the security information.

8. The method as claimed in claim 7, wherein the validation information comprises:
device authentication information,
position information,
user authentication information, and/or
application information of a user device.

9-10. (canceled)

11. A method for transmitting security information operable to release a lock protecting access to a device, the method comprising:
receiving device identification information including a visual recording of an identification of the device;
checking the identification information against a stored criterion;
transmitting the security information in response to a result of checking the device identification information, the security information associated with the identification information; and
transmitting a visual aid for using the security information to access the device.

12. The method as claimed in claim 11, further comprising:
transmitting a data record comprising a visual display with at least one extract of an image of the device and the display of the security information;
evaluating a user action arranged on or relative to the device;
receiving validation information before transmitting the security information; and/or
checking the validation information before transmitting the security information.

13. (canceled)
